(19) United States
(12) Patent Application Publication
(10) Pub. No.: US 2008/0178468 A1
(43) Pub. Date: Jul. 31, 2008

(54) HAIR CLIPPER WITH IMPROVED BLADE CONTROL STRUCTURES

(75) Inventor: Yi-Tang Liao, Taichung County (TW)

Correspondence Address: BROWDY AND NEIMARK, P.L.L.C.;624 NINTH STREET, NW, SUITE 300, WASHINGTON, DC, 20001-5303, US

(73) Assignee: Jeng Shyuan Precision Co., Ltd., Wurih Township (TW)

(21) Appl. No.: 12/022,441

(22) Filed: Jan. 30, 2008

(30) Foreign Application Priority Data
Jan. 30, 2007 (DE) 202007001336.1

(51) Int. Cl. B26B 19/00; B26B 11/00

(52) U.S. Cl. 30/34.05; 30/201; 30/196; 30/123

(57) ABSTRACT

An electric hair clipper with improved blade control structures for adjusting a scissors kit includes a combination housing provides a knob fitting portion, a pivot portion, an axial guiding slot, a motor receiving portion and a motor fixing portion. An adjusting knob provides a knob body and a pivot portion that pivots on the pivot portion of the combination housing, a turning operation portion around the adjusting knob for the finger to fiddle with and a pusher driving portion formed continuous various distance radially from the center of the pivot portion, an elastic orientation part is placed between the knob body and the combination housing. A motor unit is provided in the combination housing. A sliding pusher provides a body; a driven link portion that driven by the pusher driving portion of the adjusting knob to make the sliding pusher slide, a push head can push against the scissors kit.

### BACKGROUND OF THE INVENTION

1. Field of the Invention

The present invention relates to a hair clipper and more particularly to an electric hair clipper with improved blade control structures.

2. Description of the Related Art

In prior art, an electric hair clipper kit usually provides a control device for adjusting the blade to a suitable cutting depth. The control device is a rotatable loop that mounts on the middle section of the hair clipper and cooperates with the transmission structures that sets inside the hair clipper to match a related or plurality related effects. However, the operation is inconvenience and structures inside the hair clipper are limited and the orientation effect is unclear. The disadvantages still need to improve.

### SUMMARY OF THE INVENTION

The present invention has been accomplished under the circumstances in view. The main object of the present invention is to provide an electric hair clipper with improved blade control structures and the hair clipper can use a unique operation method to provide the easy moving and orientation effect. The sub object of the present invention is to provide an electric hair clipper with improved blade control structures and the transmission structures inside the hair clipper are simple and the link actions are clear.

To achieve those objects of the present invention, an electric hair clipper with an improved blade control structures for adjusting a scissors kit, the hair clipper of present invention, comprising: a combination housing provides a knob fitting portion, a pivot portion with an axial guiding slot, a motor receiving portion and a motor fixing portion. An adjusting knob provides a knob body and a pivot portion that pivots on the pivot portion of the combination housing, a turning operation portion around the adjusting knob for the finger to fiddle with and a pusher driving portion formed continuous various distance radially from the center of the pivot portion, an elastic orientation part is placed between the knob body and the combination housing. A motor unit is provided at a predestination place of the combination housing. And a sliding pusher provides a body, a driven link portion that driven by the pusher driving portion of the adjusting knob and moved along the axial guiding slot of the combination housing to make the sliding pusher slide, and a push head can push against the scissors kit.

### BRIEF DESCRIPTION OF THE DRAWINGS

FIG. 1 is an exploded view of a hair clipper of a preferable embodiment according to the present invention.

FIG. 2 is an exploded view of part of the hair clipper of the embodiment according to the present invention.

FIG. 3 is an exploded view of two sub-assembly of the embodiment according to the present invention.

FIG. 4 is a longitudinal section view of the embodiment according to the present invention.

FIG. 5 corresponds to FIG. 4, showing a movable blade set of a scissors kit elevated forwards.

FIG. 6 is a transverse section view of the embodiment according to the present invention.

### DETAILED DESCRIPTION OF THE INVENTION

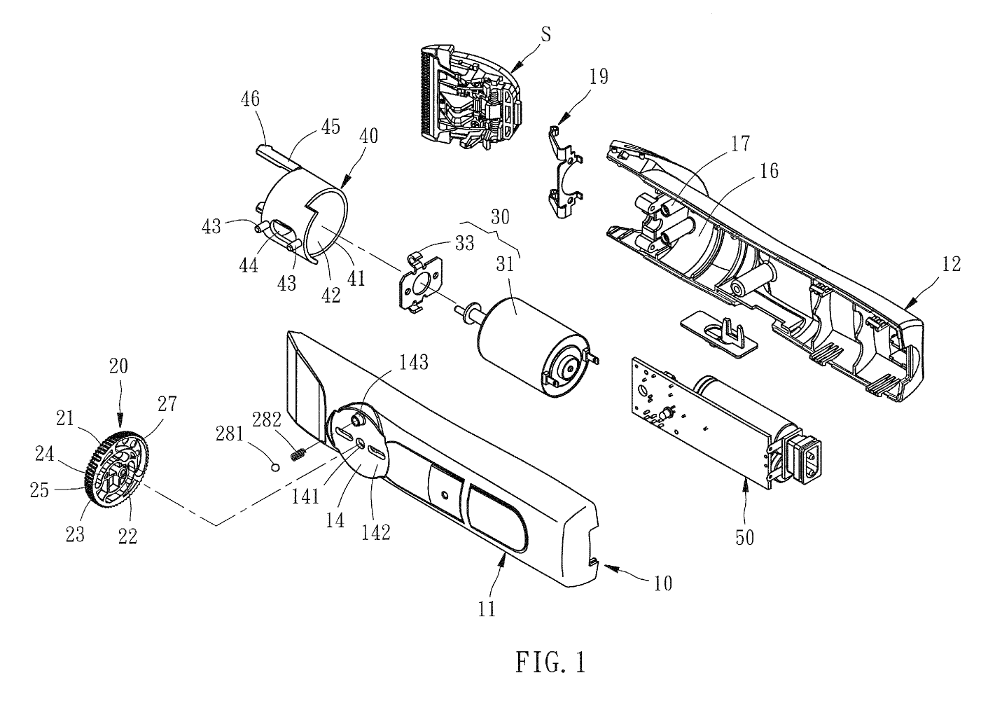

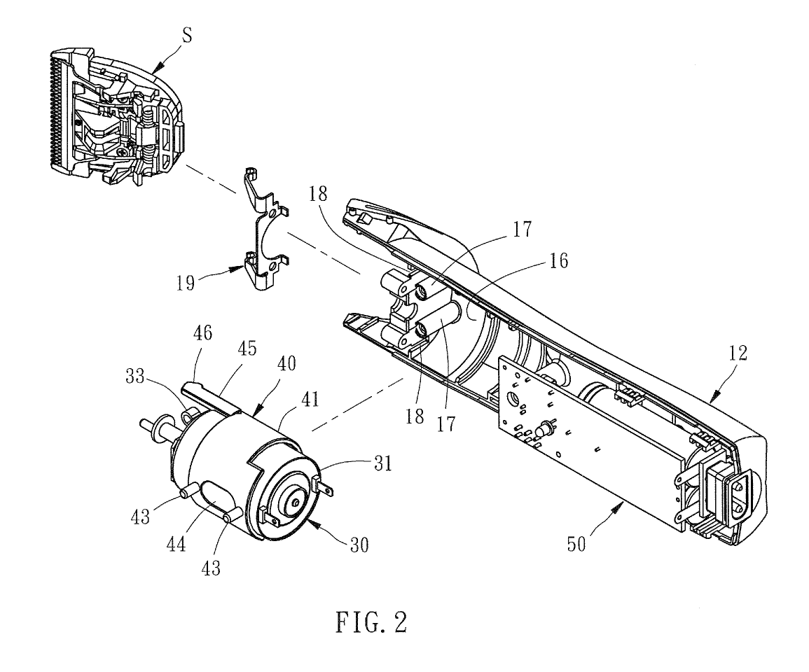

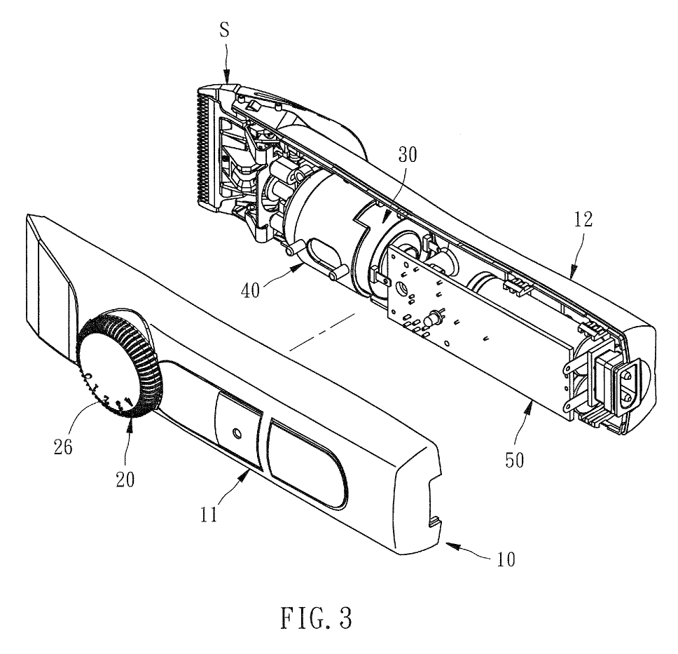

Referring to the FIG. 1 to FIG. 3, an electric hair clipper with improved blade control structures is used to control a biasing unit S1 and a movable blade set S2 of a scissors kit S. The electric hair clipper comprises:

A combination housing 10 consists of a first shell 11 and a second shell 12. There is a knob fitting portion 14 provided on the first shell 11 and it provides a pivot portion 141, two axial guiding slots 142, and a pit 143. The first shell 11 combine with the second shell 12 to form a motor receiving portion 16, two motor fixing portions 17 are two holes with screw, two coordination portions 18 are two fillisters, and a scissors snapper 19 mounted on the front end of the second shell 12 for snapping the scissors kit S onto the combination housing 10.

An adjusting knob 20 with a knob body 21 formed a pivot portion 22 that pivots on the pivot portion 141 of the combination housing 10. There is a turning operation portion 23 around the adjusting knob 20 for the finger to fiddle with. Two pusher driving portions 24 that are two arc fillisters are provided at the same diameter and have one center eccentric from the pivot portion 22, each pusher driving portion 24 formed continuous various distance radially from the center of the pivot portion 22. A plurality of continuous orientation portions 25 are provided separately on the inside and outside flange of each pusher driving portion 24. An indicating sign 26 is placed on the up surface of the adjusting knob 20. A plurality of pits 27 are provided on the knob body 21. A steel ball 281 and a spring 282 are placed between the pit 27 and the pit 143 of the combination housing 10 therein and the steel ball unites with the spring 282 to form an elastic orientation part.

A motor unit 30 has a motor 31 with cylinder shape is placed inside the motor receiving portion 16 of the combination housing 10, a fixing supporter 33 connected to the motor 31 and screwed to the motor fixing portions 17 of the combination housing 10.

A sliding pusher 40 provides a body 41 with barrel shape and a cylinder space 42 therein. The sliding pusher 40 is movable placed around the motor 31 of the motor unit 30. Two driven link portions 43 that can moved with the pusher driving portion 24 of the adjusting knob 20 to make the sliding pusher 40 moves axially. An escape hole 44 that can receive the pivot portion 22 of the adjusting knob 20 and allows the pivot portion 22 to slide therein. Two match portions 45 are sliding provided in the coordination portions 18 of the combination housing 10 and the front end of each match portion 45 forms a push head 46 to push against the biasing unit S1 of the scissors kit S.

A battery set 50 is provided at a predestination place of the combination housing 10 therein.

Hereinafter are the descriptions of the operation method of present invention.

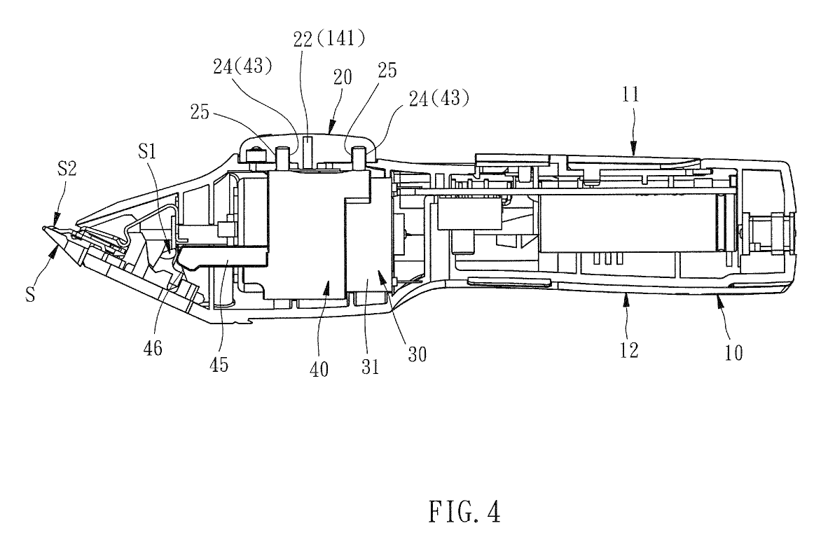

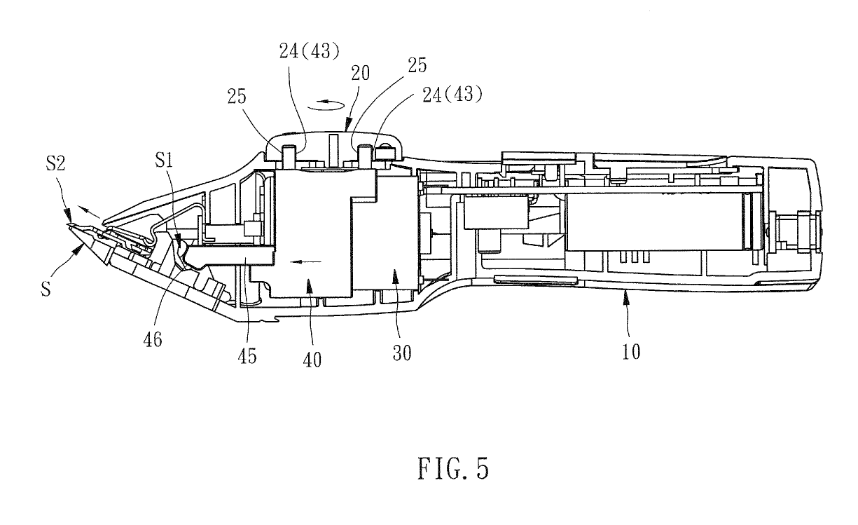

Referring to FIG. 4, by fiddling with the turning operation portion 23 of the adjusting knob 20 to rotate the adjusting knob 20, the pusher driving portion 24 of the adjusting knob 20 can push the driven link portions 43 of the sliding pusher 40 to move along an axis and force the sliding pusher to move along an axis. The match portion 45 and the push head 46 will relate with the scissors kit S to push the biasing unit S1 biased and move the movable blade set S2 upward as shown in FIG. 5. So, the scissors kit S can be adjusted.

On the contrary, the scissors kit S will move downward if the adjusting knob 20 rotates in contrary direction.

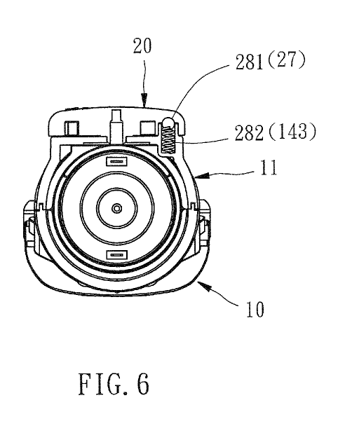

Referring to FIG. 6, because of the steel ball 281 is pushed by the spring 282; the steel ball 281 can provide an orientation effect by cooperating with the pit 27 of the adjusting knob 20. By this way, the adjusting knob 20 can be hold motionless and prevent the move that cause by shake.

Concluding with the aforesaid embodiment, the advantages of present invention are:

1. In the electric hair clipper with improved blade control structures of present invention, the hair clipper can use a unique operation method to provide the easy moving and orientation effect of the movable blade set of the scissors kit.

2. In the electric hair clipper with improved blade control structures of present invention, the transmission structures inside the hair clipper for the adjusting knob driving the sliding pusher are simple and the link actions are clear.

What is claimed is:

1. An electric hair clipper with improved blade control structures for adjusting a scissors kit, said hair clipper comprising:
a combination housing provides a knob fitting portion, a pivot portion, an axial guiding slot, a motor receiving portion and a motor fixing portion;
an adjusting knob with a knob body and a pivot portion that pivots on said pivot portion of the combination housing, a turning operation portion around said adjusting knob for the finger to fiddle with, a pusher driving portion formed continuous various distances radially from the center of said pivot portion of the adjusting knob, an elastic orientation part is placed between the knob body and said knob fitting portion of the combination housing;
a motor unit being provided at said motor receiving portion of the combination housing and fixed on said motor fixing portion of the combination housing;
a sliding pusher provides a body, a driven link portion that driven by said pusher driving portion of the adjusting knob and moved along said axial guiding slot of the combination housing to make the sliding pusher move, a push head being provided to push against said scissors kit.

2. The hair clipper as claimed in claim 1, wherein said combination housing provides two axial guiding slots, said adjusting knob has two pusher driving portions and said sliding pusher has two driven link portions, wherein said pusher driving portions of the adjusting knob that are arc fillisters being provided at one diameter and having one center eccentric from said pivot portion thereof.

3. The hair clipper as claimed in claim 2, wherein said pivot portion of the adjusting knob pivot to the center of said pivot portion of the combination housing by an axis.

4. The hair clipper as claimed in claim 3, wherein said combination housing provides two coordination portions that are two fillisters, said sliding pusher provides two match portions sliding placed in said coordination portions of the combination housing.

5. The hair clipper as claimed in claim 4, wherein said sliding pusher provides a body with barrel shape and a cylinder space, said sliding pusher is movable placed around the motor unit.

6. The hair clipper as claimed in claim 3, wherein said sliding pusher provides a body with barrel shape and a cylinder space, said sliding pusher is movable placed around the motor unit.

7. The hair clipper as claimed in claim 2, wherein said combination housing provides two coordination portions that are two fillisters, said sliding pusher provides two match portions sliding placed in said coordination portions of the combination housing.

8. The hair clipper as claimed in claim 7, wherein said sliding pusher provides a body with barrel shape and a cylinder space, said sliding pusher is movable placed around the motor unit.

9. The hair clipper as claimed in claim 2, wherein said sliding pusher provides a body with barrel shape and a cylinder space, said sliding pusher is movable placed around the motor unit.

10. The hair clipper as claimed in claim 2, wherein each pusher driving portion of the adjusting knob provides a plurality of continuous orientation portions separately thereon, said knob body of the adjusting knob provides a plurality of pits to receive the elastic orientation part, said knob fitting portion of the combination housing provides a pit for said elastic orientation part to place.

11. The hair clipper as claimed in claim 1, wherein said pivot portion of the adjusting knob pivot to the center of said pivot portion of the combination housing by an axis.

12. The hair clipper as claimed in claim 11, wherein said combination housing provides two coordination portions that are two fillisters, said sliding pusher provides two match portions sliding placed in said coordination portions of the combination housing.

13. The hair clipper as claimed in claim 12, wherein said sliding pusher provides a body with barrel shape and a cylinder space, said sliding pusher is movable placed around the motor unit.

14. The hair clipper as claimed in claim 11, wherein said sliding pusher provides a body with barrel shape and a cylinder space, said sliding pusher is movable placed around the motor unit.

15. The hair clipper as claimed in claim 11, wherein each pusher driving portion of the adjusting knob provides a plurality of continuous orientation portions separately thereon, said knob body of the adjusting knob provides a plurality of pits to receive the elastic orientation part, said knob fitting portion of the combination housing provides a pit for said elastic orientation part to place.

16. The hair clipper as claimed in claim 1, wherein said combination housing provides two coordination portions that are two fillisters, said sliding pusher provides two match portions sliding placed in said coordination portions of the combination housing.

17. The hair clipper as claimed in claim 16, wherein said sliding pusher provides a body with barrel shape and a cylinder space, said sliding pusher is movable placed around the motor unit.

18. The hair clipper as claimed in claim 16, wherein each pusher driving portion of the adjusting knob provides a plurality of continuous orientation portions separately thereon, said knob body of the adjusting knob provides a plurality of pits to receive the elastic orientation part, said knob fitting portion of the combination housing provides a pit for said elastic orientation part to place.

19. The hair clipper as claimed in claim 1, wherein said sliding pusher provides a body with barrel shape and a cylinder space, said sliding pusher is movable placed around the motor unit.

20. The hair clipper as claimed in claim 19, wherein each pusher driving portion of the adjusting knob provides a plurality of continuous orientation portions separately thereon, said knob body of the adjusting knob provides a plurality of pits to receive the elastic orientation part, said knob fitting portion of the combination housing provides a pit for said elastic orientation part to place.
